(19) United States
(12) Patent Application Publication
(10) Pub. No.: US 2015/0095756 A1
(43) Pub. Date: Apr. 2, 2015

(54) Method and apparatus for multi-loop, real-time website optimization

(71) Applicants: Zijad F. Aganovic, Delray Beach, FL (US); David L. Henrickson, Redmond, WA (US)

(72) Inventors: Zijad F. Aganovic, Delray Beach, FL (US); David L. Henrickson, Redmond, WA (US)

(21) Appl. No.: 13/998,098

(22) Filed: Oct. 1, 2013

(51) Int. Cl. G06F 17/22

(52) U.S. Cl. CPC G06F 17/2247
USPC 715/234

(57) ABSTRACT

A method for automated, real-time adaptive website optimization at least includes: a) receiving matching data about web pages use in an optimization campaign; b) receiving configuration data for website optimization applications; c) receiving optimization criteria; d) receiving a referent performance value; e) receiving instructions for capturing visitor activity data; f) initializing a real-time, adaptive website optimization algorithm for optimizing overall website performance; g) establishing web page treatment options; h) detecting a website visitor; i) matching a website visitor with one or more web pages; j) treating web pages in real-time in accordance with the optimization algorithm's control; k) capturing website visitor activity data; l) calculating website performance for each of the web page treatments; m) calculating feedback by comparing the referent performance and the website performance; n) providing feedback to the optimization algorithm; and o) determining web page treatment for future web pages presented.

### BACKGROUND OF THE INVENTION

1. Field of the Invention

The present invention relates to schemes for automatic and intelligent optimization of websites across multiple web pages, multiple visitor segments, multiple types of content elements, multiple web applications, and the like.

2. Background

A typical website consists of a number of web pages, with each webpage having a large number of page elements, such as navigation elements, headlines, images, buttons, and product descriptions. A web page element could also be a web application, like a “social widget,” a trust badge, a lead or a search form.

Website optimization involves modifying websites for optimal effectiveness so that website visitors will be influenced to engage in a maximum amount of predefined activities. A complex undertaking, effective website optimization may be measured in many ways, including the amount of time website visitors spend on the website in question, the website conversion rates (i.e., the rates at which website visitors engage in desired business activity while visiting the website), number of “clicks,” number of leads, and revenue generated from website visits. As part of website optimization, web testing solutions are used to vary the web page element content, layout, style attributes, and other aspects of how information is presented, in search of the version of the web page or sets of web pages that result in the best website performance. One major challenge in website optimization testing is that variation of web page elements creates a large number of permutations within the web pages, leading to perhaps millions of possible versions of a single web page.

Multivariate optimization testing solutions are designed to enable the contemporaneous variation of multiple web page elements for multiple simultaneous changes to a web page in search of the top performing version of the web page. Each element variation interacts and creates an impact to all other elements of the website, which could ameliorative, deleterious or neutral. Since testing website variations is not simply a matter of mathematical computations in a vacuum to find the best web page, it is necessary to test web page versions with the actual reactions of live website visitors.

To avoid the complexity associated with the design and the implementation of multivariate tests, and above all, to shorten time needed for reliable test results, many website testing vendors advise their clients to run multiple A-B tests (where one web page element is varied at a time) instead of a single multivariate test. After finding the best version of each web page element the practitioners of the multiple A-B testing methodology simply corns pile the testing results and apply all “winning” versions (i.e., those receiving the most positive response from website visitors during the test) of each tested element to a single web page and expect that the overall best web page has been generated. However, discretely varying separate elements without any idea of the impact on the other elements is no guarantee that an improved web page will be produced, let alone the best web page. The magnitude of the element variation interaction is very significant and simply should not be ignored.

Those skilled in multivariate web page testing understand that the use of multiple A-B tests as a substitute for a single multivariate test is almost certain to produce underperforming versions of the web pages. As an analogy, medical patients could be prescribed two different medications as part of a trial. Each medication when used alone might produce consistently strong results with a great majority of patients. However, in many cases, the combination of the two medications is not only non-synergistic, but the interaction between the two medications might trigger undesirable or even dangerous side effects that might make medicated patients worse than if they had not taken the trial medications. In the same vein, two winning web page elements (which were separately and discretely tested) when combined together, will interact and most likely produce a negative overall result (i.e., a website producing worse results than it produced before the testing). Therefore, prior art website optimization techniques which do not take into account the impact of individual element variation on other elements are greatly deficient.

Prior art multivariate website optimization testing approaches, while having benefits over multiple A-B testing approaches, introduce other challenges. The first and most obvious challenge is the fact that a limited number of the element variations create a large number of combinations of how these variations can be presented on the web page, which then requires a large number of visitors and a long testing duration to achieve statistically valid test results. Thus, the full factorial (i.e., every variation of an element) multivariate testing solutions that test all possible versions of the web page are highly inefficient. Consequently, a majority of multivariate testing solution providers rely on fractional factorial (i.e., a limited number of variations of an element) methods where only a small fraction of all possible web page versions are tested. The test results are then statistically analyzed to predict which web page version in the pool of all possible web page versions should be the best. But alas, such predictions are very unreliable, forcing website owners to run waves of fractional factorial tests in search of effective websites.

The traditional multivariate testing methods can be generalized as “open loop” methods, analogous in some respects to open loops in control theory. That is, open loop testing does not use real-time feedback in its decision making. Instead, the tests are executed in accordance with a test plan, the data is collected and processed, and then a human operator makes a decision about the next step. Prior art multivariate testing is exemplified by the description in U.S. Patent Application Number US 2010/0100419 by Natoli, et al.

Another challenge of the multivariate testing is that the multivariate tests are almost certain to produce a drop in the website performance results during the duration of the test. The real life experiences of many full factorial multivariate tests reveal that 80 to 90 percent of all web page versions included in the multivariate test have worse performance than the existing, pre-test web page. This implies that fractional factorial tests would most likely have more “losers” than “winners,” dragging down website performance during the test.

FIG. 1 illustrates an example of a generalized prior art open loop website optimization system 100. During an optimization campaign, when website visitors 110 reach a web page that belongs to a group of test web pages 120 included in a current test, a web page treatment module 130 receives a treatment data package 140 from a test controller 150, and performs page changes in accordance with the treatment data. The treatment data package contains web page change instructions along with related new web content and/or new web functionality. The treatment data package might also contain an instrumentation code that enables visitor activity tracking.

Visitor activity data 170 is captured and used to calculate and report test results 180 to a human operator, who can run the current test until statistically significant results are achieved. At the end of the test the operator can analyze the test results and make decisions about further actions. The test controller 150 is pre-configured during a test setup step via a symbolic input 160.

The open loop control methods are used both by A-B split testing and multivariate Testing (MVT) solution providers. During practical implementation of an open loop approach, vendors might use different web page treatment steps. For example, some vendors might “pre-bake” different versions of the web pages and publish them as standalone web pages, using the web page treatment module 130 to re-direct a visitor to an alternate version of the web page. Others might use page scripting or a proxy server to dynamically alter the existing web page.

In addition to “open loop” methods, multivariate optimization testing methods are also classified as “feed-forward” methods, where decisions are autonomously made based on pre-defined rules or a model. These represent improvements over pure open loop approaches, but feed-forward approaches are still limited because they do not fully take into account the impact of the real time results of the actions taken by their respective systems. One example of a feed-forward approach is U.S. Pat. No. 8,166,155 to Rachmeler, et al., which discloses a multivariate technique for website experimentation with the primary goal of assessing in real time, the impact of “bad” page elements on visitor behavior. Additionally, U.S. Pat. No. 8,234,632 to Hugeback, et al. discloses an adaptive website optimization experiment for multivariate testing that uses collected data and pre-defined rules to reduce the amount of traffic allocated to underperforming versions of the web pages. Further prior art is represented by U.S. Pat. No. 7,966,564 to Catlin, et al. which discloses a version of a real-time optimization method that uses training data to perform offline statistical analysis to build a predictive model and then to use the predictive model to present more versions of web pages that are predicted to perform well for different types of visitors (referred to as “earners”) while in parallel presenting other versions of the web page needed for continued training of the algorithm (“learners”).

In addition to technical complexity, number of visitors, and negative impact to website results, the traditional multivariate testing methods are made ineffective by the time varying nature of the web visitor behavior. Offline statistical modeling in the Catlin, et al. approach, or predefined testing in the Rachmeler, et al. approach make sense only if visitor behavior is static. In reality, web visitor behavior is dynamic, changing from one time interval to another, and test results may not be valid for long periods.

Website visitor behavior is often very difficult to predict—even when demographic and past behavior information about the particular visitors is available. Owing to characteristics and traits such as social status, gender, age, education backgrounds, macroeconomic and microeconomic conditions, personal preferences, the current time, and others, the behavior of unique website visitors is not at all easy to model with respect to their reactions to web pages. To make matters more difficult, the preferences and tendencies of most website visitors are little- or unknown, making predicting the reactions to various web pages little more than guesswork. There is simply no causal reaction model for web visitor behavior that will predict with certainty what will work with even a particular type of visitor. It therefore follows that no causal model can accurately predict the behavior of all types of visitors for all types of websites, and for all types of external factors. A combination of the plurality of variable factors above with the variability of traffic sources and ratios of different types of visitors included in the overall traffic produces a huge magnitude in variance of how visitors behave from one time interval to another.

To the extent that predictive modeling produces any useful predictions, such as disclosed in U.S. Pat. No. 7,966,564, the predictions are often obsolete with the passage of time. Similarly, other methods such as the one described in U.S. Pat. No. 8,234,632, which attempts to penalize a “bad” web page based on the cumulative test data, can be quite risky. For example, test results for the “bad” version of the page might be statistically significant, while the data might present a very misleading picture about performance of that web page. Namely, cumulative data that were used by the system to make a decision will cause the system to eliminate a “bad” web page from the test and overweight traffic to a “good” web page. This approach ignores trends such as an improving performance of “bad” web pages, or a declining performance of “good” web pages. For example, the “bad” web page might be experiencing a strong performance in the last few days with a strong upward trend and the “good” web page might be heading in the opposite direction, where the results from the last few days are weak and trending negatively. This application of a static feed-forward algorithm would make the situation worse rather than better.

FIG. 2 illustrates an example of a generalized prior art feed-forward website optimization system 200 in line with the previously-mentioned U.S. Pat. Nos. 7,966,564 and 8,166,155. Similar to the approach in FIG. 1, when website visitors 210 reach a web page that belongs to a group of test web pages 220 included in current test, a web page treatment module 230 receives a treatment data package 240—this time from a rules based adaptive test controller 250—and performs web page changes in accordance with the information contained in the treatment data package. Visitor activity data 270 is captured and used to calculate the test results 280. The difference between open-loop and the rules-based adaptive testing methods is the use of rules based adaptive logic (via module 250) that employs stored rules to decide the portion of website visitor traffic that will be allocated to different versions of the web page based on the test results 280.

It is important to note that the rules-based approach in FIG. 2 and its related prior art is driven by static logic, and not by real-time intelligent decision making. U.S. Pat. No. 8,166,155 for example, teaches minimizing testing cost through the use of an adaptive algorithm whose logic consists of pre-defined rules symbolically represented by input 264 and statistical thresholds (via the symbolic test setup input 260) for selecting and allocating more web traffic to preferred versions of the web pages. To minimize the impact of the time-varying behavior of web visitors, the testing is performed in multiple phases and ends when it becomes substantially certain that a better option has been identified.

To enhance the ability to adapt to changes in the website visitor behavior, U.S. Pat. No. 7,966,564 teaches the use of offline system modeling to periodically refresh the rules (264) on offline analysis test results 280. The two approaches are similar, but different in that the rules are either pre-configured and static during the entire test, or periodically changed based on the most recent statistical data.

Effectively taking into account the time varying nature of website visitor behavior during website optimization testing is scarcely addressed by the prior art. One prior art approach to multivariate website optimization that addresses the time varying nature of website visitor behavior is U.S. Pat. No. 8,321,359 by Buchs, et al., and assigned to Hiconversion, Inc., the assignee of the present Letters Patent, for “Method and Apparatus for Real-Time Website Optimization,” which is hereby incorporated by reference. The key aspects of that letters patent are the use of a feedback loop and a machine-learning algorithm to intelligently adapt to web visitor behavior in real time.

FIG. 3 illustrates an example of a generalized prior art closed loop, real-time website optimization system 300 in line with the previously-mentioned U.S. Pat. No. 8,321,359. Similar to the approaches of FIGS. 1 and 2, when website visitors 310 reach a web page that belongs to a group of test web pages 320 included in current test, a web page treatment module 330 receives a treatment data package 340—this time from a real-time adaptive optimization controller 350—and performs page changes in accordance with the information contained in the treatment data package. Visitor activity data 370 is captured and used to calculate the test results 280.

The real-time adaptive controller 350 uses machine learning to continually predict which web page versions should perform the best, and then presents those versions of the web pages more often while using test results 380 to continually improve the statistical model of the web visitor behavior and the precision of its predictions. A key departure of this method from the other prior art approaches is the use of a feedback loop and machine learning algorithm to intelligently adapt to website visitor behavior in real time.

In addition to the element interaction and time-varying complexities mentioned above, website optimization is increasingly made more difficult by the fact that independent applications, which help to produce web pages, may affect the resulting web page appearance and functionality. Some embedded website applications are designed to optimize the website performance by enhancing certain discrete aspects of web pages for improved visitor experience. An example of an embedded optimization application is one that targets solutions that will use visitor segmentation data to “play” a more personalized content to that group of visitors. Another example is a product recommendation application that presents additional products with the goal of helping a visitor match a product with his or her preferences, or to easier find a product that fits his or her preferences or to provide complimentary products. A third example is a merchandizing module that places promotional badge images on different products or plays coupons and other price incentives to visitors who exhibit certain onsite behavior. These applications represent a new breed of web page objects known as autonomous optimization applications that control the content and appearance of targeted elements by their own application logic. During optimization campaigns, these autonomous optimization applications can be viewed as additional website control loops functioning alongside more general website optimization control loops, such as the approach in U.S. Pat. No. 8,321,359. Similar to interactions of the multivariate web page elements, the actions made by the autonomous applications also interact with each other. In other words, an action made by an application in its own control loop affects in some way other applications and their control loops and results.

In order for an improved website optimization solution, all of the problems associated with the prior art optimization approaches must be addressed in a contemporaneous manner.

### SUMMARY OF THE INVENTION

The invention includes a method and apparatus for full, automated, self-learning (adaptive) multi-loop website optimization that consists of one or more optimization campaigns and/or one or more embedded optimization web applications contemporaneously running, where variable elements included in the optimization campaign might, in addition to content, layout, and functional changes of the web pages, also be an embedded web applications that have their own ability to perform website optimization functions. The new approach is not limited to a particular optimization methodology or a particular optimization algorithm, or type of embedded web optimization applications, or type of the embedded web optimization application control loop. Instead, it is a framework that enables the use of the existing or new inventive optimization methods or algorithms in website optimization in closed loop applications to optimize performance of any type of web content, style, layout, functionality, or embedded web optimization application in real-time.

The present-inventive method and apparatus include the ability to optimize the overall performance of a website with one or more web pages, for one or more web visitor groups at the same time, when website optimization is carried out by one or more of optimization campaigns and/or one or more embedded web optimization applications, where an optimization campaign can have one or more variable components whose values could include changes or additions to the existing website content, layout, and functionality. The present invention also includes the ability to define types of visitor activity data that will be captured during the optimization process, including but not limited to order values, product pricing, time on site, conversions, click throughs, etc., the ability to define one or more performance metrics, the ability to define a referent website performance which might represent website performance without any optimization or desired website performance that should be achieved through the optimization process, the ability to define the optimization criteria for one or more optimization campaigns, and the ability to define how one or more optimization campaigns and/or embedded web applications will work together as the part of multi-loop optimization process of the web funnel. The present invention additionally includes the ability to auto-initialize the multi-loop optimization process, the ability to automatically generate real-time changes in the website in accordance with the optimization logic, the ability to collect website performance data and calculate optimization results for one or more performance metrics, the ability to find the difference between referent website performance and the actual website performance, and the ability to use the difference between referent website performance and the actual website performance and other website performance data as feedback for one or more of optimization campaigns and/or embedded web applications. The present invention optionally includes the ability to exchange data between optimization campaigns and/or embedded web applications, the ability to compile and report data statistics that provide an insight into importance of variable components to overall performance of the website, the ability to add, remove, or edit variable components of one or more optimization campaigns during live optimization process, and the ability to run one or more of optimization campaigns at the same time while ensuring the optimum performances of the entire website. The automated website changes that are driven by one or more of the optimization algorithms adapt to visitor preference in real time while attempting to converge toward the optimum solution for the entire web funnel at all times. The method can be applied to any type of website, programmed in any type of programming language, regardless of the number of website technology levels and components, type of operating system and web server, or types of embedded web optimization applications.

The benefits achieved by this approach are: 1) sustainable end-to-end optimization results across multiple web pages and across multiple visitor groups, multiple web page changes, multiple embedded web applications, and across extended time intervals; 2) adaptability to web visitor behavior changes, as one or more self-learning algorithms learn about changes in behavior of website visitors in real time and adopt their controlling actions accordingly; and 3) actionable insight into effective website optimization.

In view of the aforementioned problems and deficiencies of the prior art, the present invention provides a method of automated, multi-loop real-time website optimization that at least includes: a) receiving web page matching data having information about one or more web pages that will be included in a website optimization campaign for optimizing a website; b) receiving optimization configuration data for one or more website optimization applications; c) receiving optimization criteria for the one or more website optimization applications; d) receiving definitions of a referent performance value; e) receiving instructions for capturing website visitor activity data for the one or more website optimization applications; f) initializing a real-time, adaptive website optimization algorithm adapted to optimize the overall performance of the website; g) establishing web page treatment options in accordance with the website optimization algorithm's control; h) detecting that a website visitor has visited the website; i) matching a website visitor with one or more web pages according to the web page treatment options; j) treating web pages in real-time in accordance with the website optimization algorithm's control; k) capturing website visitor activity data; l) calculating website performance for each of the web page treatments; m) calculating feedback on the basis of the referent performance and the website performance; n) providing the feedback as an input to the website optimization algorithm; and o) via the website optimization algorithm, determining web page treatment to be applied to web pages to be presented to the next website visitor detected.

The present invention also provides an optimization system for the automated, multi-loop real-time website optimization that at least includes: a) an Internet device adapted to allow website access by an Internet user; b) a web server adapted to host a website; c) a web page matching module adapted to detect activity of the Internet device with respect to said website, and adapted to receive web page matching data comprising information about one or more web pages that will be included in a website optimization campaign for optimizing a website; b) a web page treatment module adapted to receive optimization configuration data for one or more website optimization applications, adapted to receive optimization criteria for said one or more website optimization applications, and adapted to treat web pages in real-time in accordance with instructions received; c) a website performance measurement module adapted to receive definitions of a referent performance value, and adapted to measure the performance of a treated website with respect to said referent performance value; d) a visitor activity data module adapted to capture website visitor activity data for said one or more website optimization applications; and e) a real-time, adaptive website optimization module operatively coupled to said website performance measure module and to said web page treatment module, and adapted to optimize the overall performance of the website via one or more real-time, adaptive optimization algorithms, adapted to receive a feedback value, said feedback value being calculated based on a comparison between said referent performance value and the performance of said website, and adapted to, based upon said feedback, instruct said web page treatment module.

Additional objectives and advantages of the invention will be further explained in the description that follows.

### BRIEF DESCRIPTION OF THE DRAWING FIGURES

Features and advantages of the present invention will become apparent to those skilled in the art from the description below, with reference to the following drawing figures, in which:

FIG. 1 is a schematic diagram of a prior art system for website optimization using an open loop testing method;

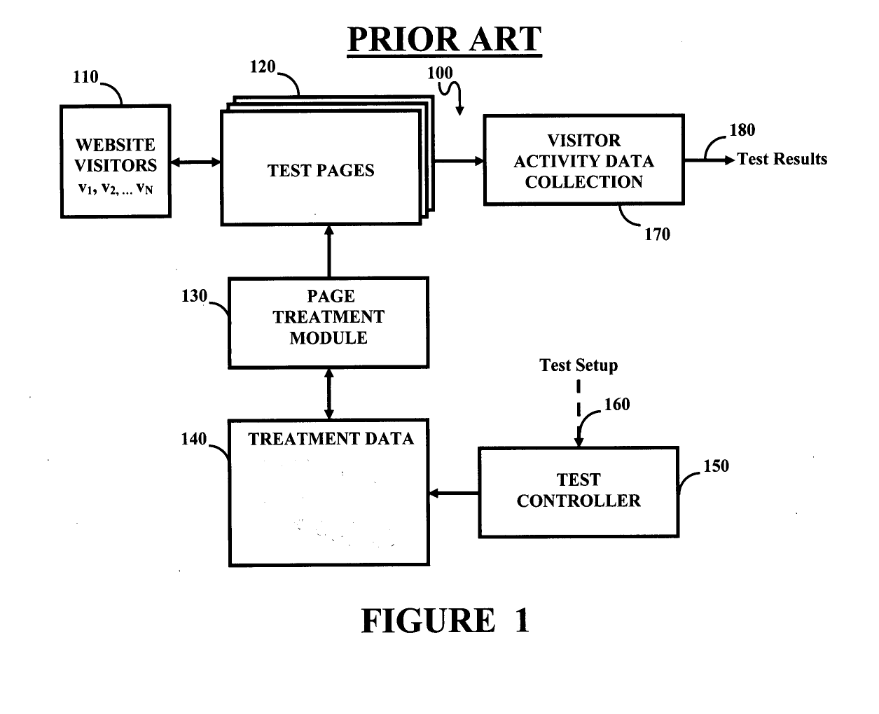

FIG. 2 is a schematic diagram of a prior art system for website optimization using a rule-based adaptive testing (“feed-forward”) method;

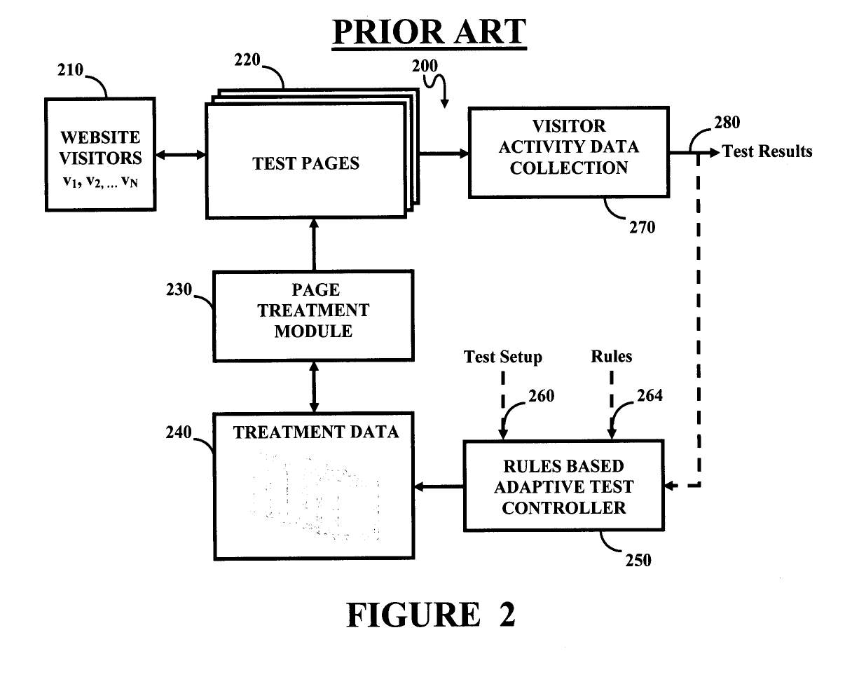

FIG. 3 is a schematic diagram of a prior art system for website optimization using a real-time, closed-loop method;

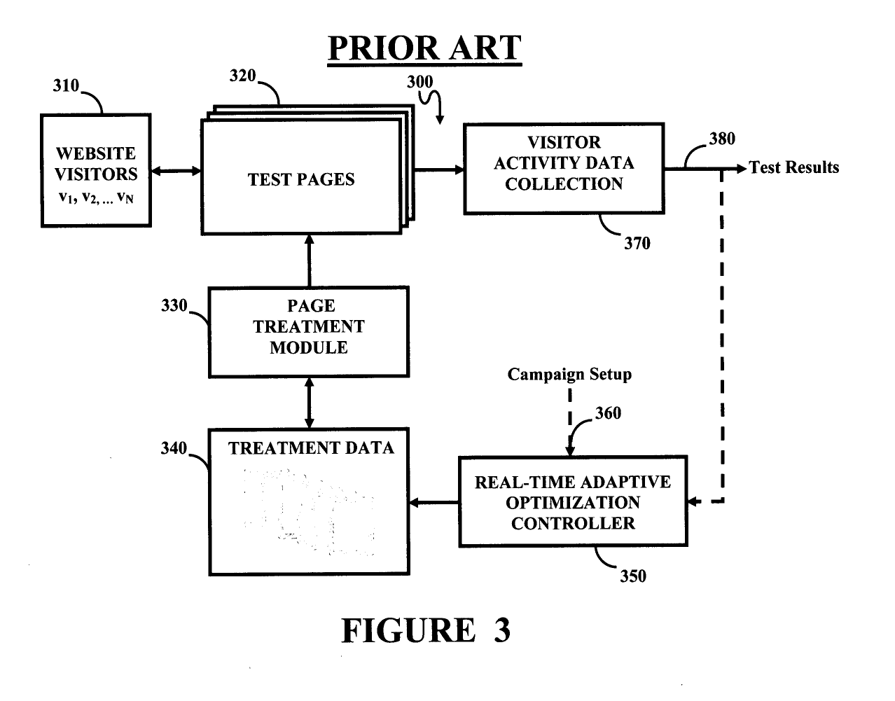

FIG. 4 is a schematic diagram illustrating a generalized, multi-loop website optimization scenario;

FIG. 5 is a schematic diagram illustrating a generalized data flow for the multi-segment case of multi-loop optimization of websites;

FIG. 6 is a schematic diagram illustrating the data flow for the present inventive real-time website optimization method with referent performance and feedback;

FIG. 7 is a schematic diagram illustrating the multi-loop optimization data flow of the present inventive real-time website optimization method with referent performance and feedback;

FIG. 8 is a schematic diagram illustrating a system according to the present invention and its data flow of multiple website optimization applications using common referent performance and feedback, and where the optimization applications are non-integrated;

FIG. 9 is a schematic diagram illustrating a system according to the present invention and its data flow of a multi-loop optimization scenario where the optimization applications are integrated;

FIG. 10 is a schematic diagram illustrating the generalized apparatus and its data flow for the real-time adaptive optimization controller used in the present inventive multi-loop website optimization system and method with reference and feedback method;

FIG. 11 is a schematic diagram of the apparatus and data flow of FIG. 10 with integration capabilities;

FIG. 12 is an example of a multi-element encoding schema used with the present invention; and

FIG. 13 is a schematic diagram of a system capable of multi-loop real-time adaptive optimization according to the present invention.

### DETAILED DESCRIPTION

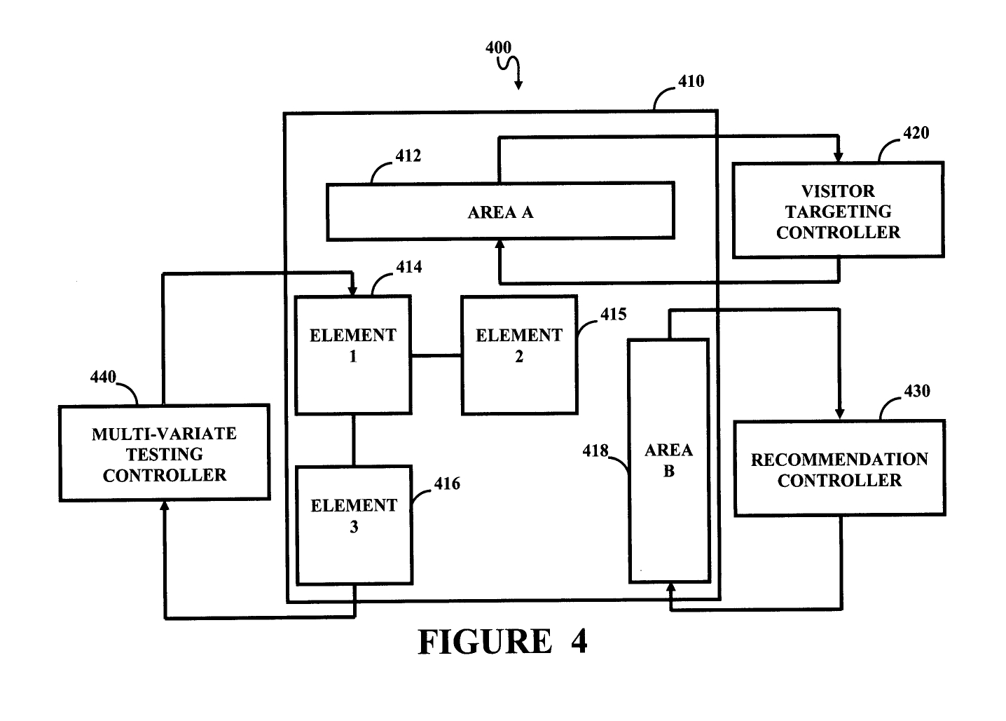

Turning to FIG. 4, a multi-loop scenario is presented in which the present invention is designed to operate. The multi-loop scenario 400 is made possible by the existence of many software applications created to help website owners to more effectively optimize website performance. As result, a single website page 410 can simultaneously run more than one optimization application to manipulate web page elements or areas of the web page in accordance with the optimization logic of the separate optimization applications. For example, a multivariate testing application using a multivariate testing controller 440 to experiment with variations of web page elements 414-416 might operate in parallel with a visitor targeting application using a visitor targeting controller 420 to show different content for different types of web visitors in the web page area A (412) and a product recommendation application using a recommendation controller 430 to present recommendation content in the Area B (418). Targeting, product recommendation, and similar applications are often referred to as embedded web applications since these applications are usually embedded into web page source code through their own integration code.

Simultaneously running multiple optimization applications creates interactions between actions taken by each application which most of time causes a negative impact on the overall performance of the website. One of the objectives of the present invention is to address and solve this problem.

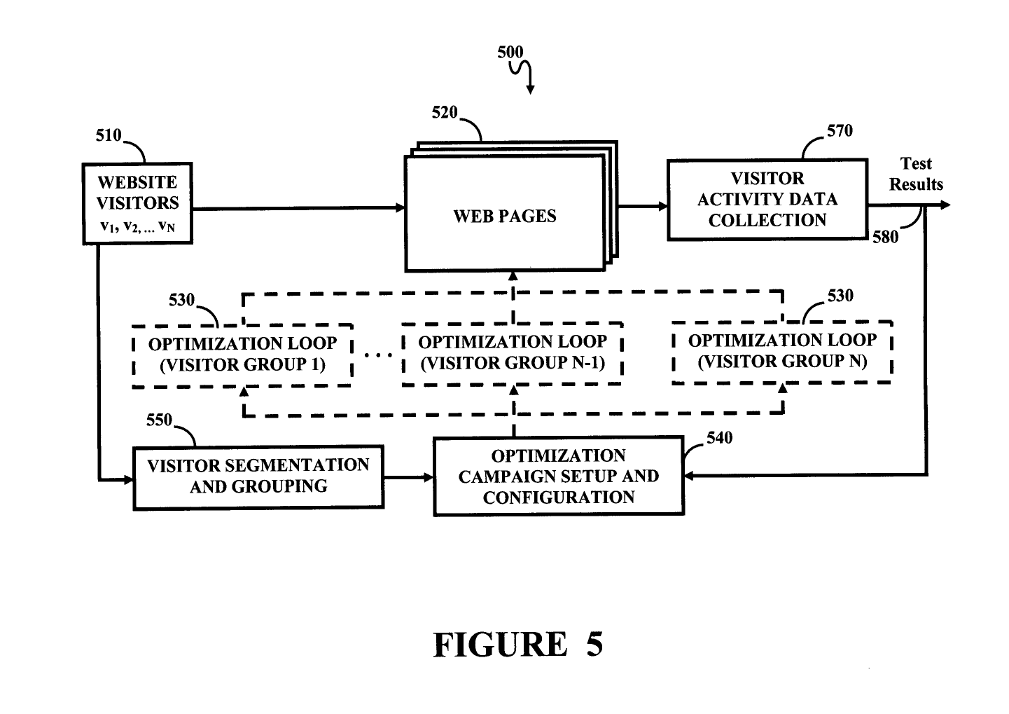

The data flow 500 of a multi-segment, multi-loop website optimization scheme is illustrated in FIG. 5.

Multiple segmentation takes into account the fact that different visitors react differently to the same web page; therefore, many website owners attempt to optimize their website performance for each separate group of website visitors. That is, once web visitors 510 reach any of the web pages 520 that are included in the current optimization campaign, a visitor segmentation and grouping mechanism 550 uses one or more visitor segmentation criteria to determine if a visitor belongs to any of the N predefined visitor groups symbolically illustrated. If so, a visitor will be assigned to one of N different optimization loops 530 that are introduced to optimize website performance for that specific group of visitors. After a web page is treated visitor activity data is collected (570) and test results 580 are calculated. All optimization loops use common optimization setup and configuration data as well as test results to perform virtual optimization loops for each of the visitor groups. The dotted lines in FIG. 5 are used to illustrate the virtual nature of the multi-optimization loops inside of a single optimization campaign setup (540).

In one embodiment of the multi-segment, multi-loop optimization scheme, each virtual optimization loop uses its own feedback values calculated on the basis of the website performance for that visitor group and associated referent website performance. In practice many visitor groups will have a very limited amount of website traffic, which will make feedback data very sparse and “noisy.” To address this issue the present invention novelly introduces an innovative method for calculating feedback values on the basis of the overall website performance or as a composite value that combines the feedback data from the virtual loop calculations and overall website performance.

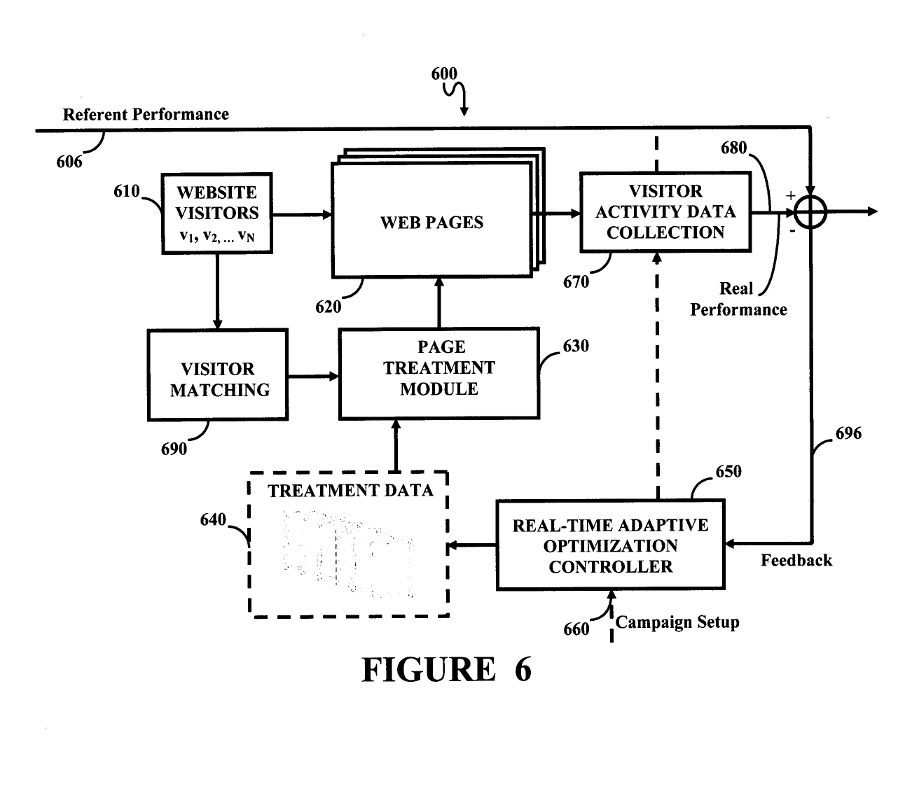

FIG. 6 illustrates the data flow 600 for the present inventive real-time website optimization method with referent performance and feedback. As described with reference to FIG. 4 and FIG. 5, the multi loop website optimization scenarios introduce additional levels of complexity because of interactions between actions taken by different optimization applications or loops. That is, in common parlance, “the left hand doesn't know what the right hand is doing.” In order to solve the multi-loop optimization problem the present invention novelly introduces two key concepts in the multi-loop website optimization environment: reference performance 606 and feedback 696.

The referent performance 606 of website is a referent value or a set of time varying values against which website performance is measured and optimized. The referent performance can be defined in multiple ways. In the preferred embodiment of this inventive methodology referent performance is defined as the real-time baseline performance of the website prior to the optimization campaign; i.e., a performance that a website will have during the exact same points in time when the same web traffic was applied to an unchanged website (version of the website that was not treated by any other testing, personalization, or optimization application). This value is often called the “control.” The referent performance can be established by a random splitting of a percentage of traffic that will be presented non-treated pages and then use the corresponding visitor activity data and website performance in the optimization process for decision-making with the goal of achieving a maximum lift in overall performance of the website.

Referent performance can be alternatively defined, for example, as a percentage lift against the base line, or some other dynamic values such as a real-time performance of a version of a treated web page or group of web pages. The concept of using a common referent performance point for at least one of the multiple optimization loops is a vital aspect of the present invention that is not taught or suggested by the prior art.

The Feedback 696 represents a value calculated on the basis of the referent performance and the website performance 680. The feedback 680 is used as an input to a real-time, adaptive optimization controller 650 to execute the optimization algorithm or algorithms and to determine which treatment data 640 will be used by a page treatment module 630 and applied to web pages 620 when website visitors 620 are detected. For example, in a preferred embodiment of the present invention the referent performance is defined as the performance of non-treated web pages, which serves as a baseline or control. The website performance can be the performance of one or more of treated web pages observed over a predefined time interval. Depending on the type of the algorithm used, the feedback could be a single value calculated on the basis of the referent performance and the website performance value, or it could be a vector with multiple values calculated on the basis of the referent performance and website performance for individual web page treatments.

The term “treatment” is used to describe all content, layout, style, or functional changes that will be made to a web page in real-time before the web page is rendered and presented to a website visitor. “Treatment” also includes all code that will be implemented to enable visitor activity tracking, such as the ability to capture sales or to detect that a visitor has completed a conversion goal. Following the presentation of web pages to visitors, visitor activity data 670 is collected and the website performance 680 is computed.

A visitor matching module 690 is used to detect a website visitor and determine which web page visitor has visited to select the appropriate optimization campaign(s) to be applied to a web page via the page treatment module. Visitor matching could also be based on the combination of web page information and visitor segmentation criteria. In the schematic diagrams hereafter, the visitor matching function will be omitted for simplicity. However, visitor matching is the integral part of any multi-loop methodology as described in this letters patent.

The real-time adaptive optimization controller 650 is configured via a campaign setup 660 which provides all campaign setup information, including variable content, instructions for web page changes, visitor activity data collection instructions, optimization goal(s), referent performance, and other information needed for running one or more optimization applications.

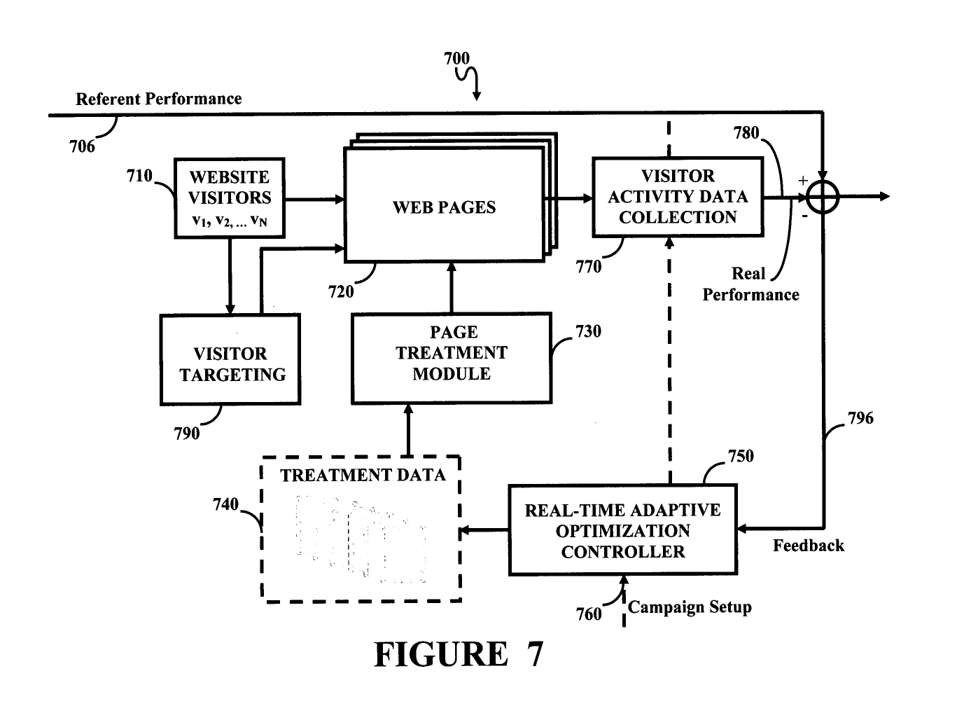

FIG. 7 illustrates the multi-loop optimization data flow 700 of the present-inventive real-time website optimization method with referent performance and feedback. To reiterate, real-time adaptive optimization with referent performance and a feedback loop are essential building blocks of the multi-loop optimization capability. Multi-loop optimization means website optimization where more than one software application is used to optimize website performance at the same time. The term “loop” is related to the decision making or control loop for each of the applications.

In the example of FIG. 7, which has non-integrated optimization applications, one of the optimization applications is carried out by the visitor targeting application 790 that acts on its own and treats web pages 720 each time its targeting rule is triggered. The other optimization application is carried out by a real-time adaptive optimization controller 750, and can be an adaptive, multivariate optimization application using feedback 796. The feedback 796 is calculated as the difference between the referent performance 706 and the real website performance 780. In this example the website performance is a composite website performance that represents the impact of two optimization applications acting at the same time. The website performance 780 is calculated on the basis of overall visitor activity 770 data. The use of feedback in combination with the real-time adaptive optimization controller 750 enables optimization of the overall website for both optimization campaigns simultaneously.

A variation of the non-integrated multi-loop optimization scenario is the case when the visitor targeting application 790 is treated as a variable included in an optimization campaign that uses the real-time adaptive optimization controller 750. Such an inclusion is practical and useful for embedded optimization applications such as visitor targeting, product recommendation, and others, and it can be carried out during the optimization setup and configuration process. The use of an embedded optimization application as a variable included into another real-time adaptive optimization application creates a potential for increasing the optimizing value of the embedded application. For example, the real-time adaptive optimization application can experiment with the location or appearance of the embedded application while ensuring that if the embedded application is not providing the desired performance lift, the embedded application is presented less often than it will be if its behavior is controlled only by its own logic.

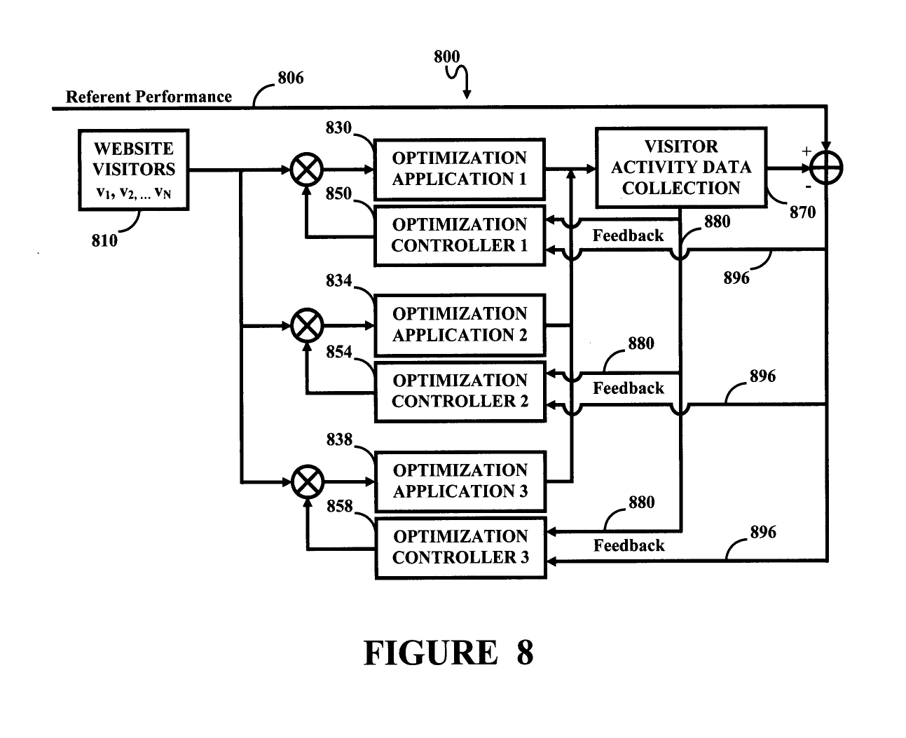

FIG. 8 further demonstrates a multi-loop optimization scheme 800 where the optimization applications are non-integrated. That is, in the example of FIG. 8, all of the optimization applications (830, 834, and 838) use the common referent performance 806 and feedback 880 from the visitor activity data 870. The optimization applications (830, 834, and 838) each have their own optimization controllers (850, 854, and 858, respectively) that decide which page treatment options are to be selected and applied to web pages for website visitors 810. Although each of the optimization applications acts independently, by virtue of their use of the common referent performance and feedback, they will all act to converge to an overall optimum solution for the entire website.

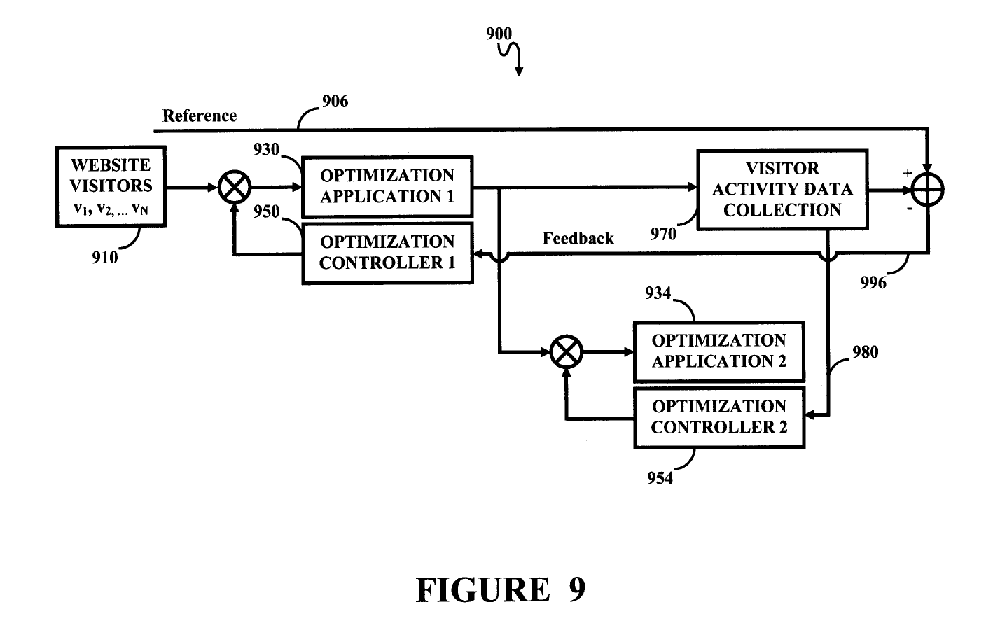

A multi-loop optimization scheme may also have integrated optimization applications such as the one 900 in FIG. 9. The optimization applications 930 and 934 are considered “integrated” because they can receive data from each other. The components 950, 954, and 970 function similarly to their counterparts, 850, 854, and 870, respectively, in FIG. 8. The “optimization application 1” 930 could be a multivariate website optimization application that acts first and decides which treatment will be applied to web pages presented to website visitors 910 participating in an optimization campaign. Likewise, “optimization application 2” 934 could be a product recommendation application which would normally make an independent decision about which product to recommend, solely based on the visitor activity data 970. However, because of optimization application integration, “optimization application 2” can enhance its decision making by taking into the account the web page treatment applied to the web pages, and as a result, act to contribute to a better overall website performance.

The schematic diagrams 700, 800, and 900 are introduced to depict just a few of many possible scenarios in which the present-inventive real-time, adaptive optimization with reference performance and feedback can be used for website optimization.

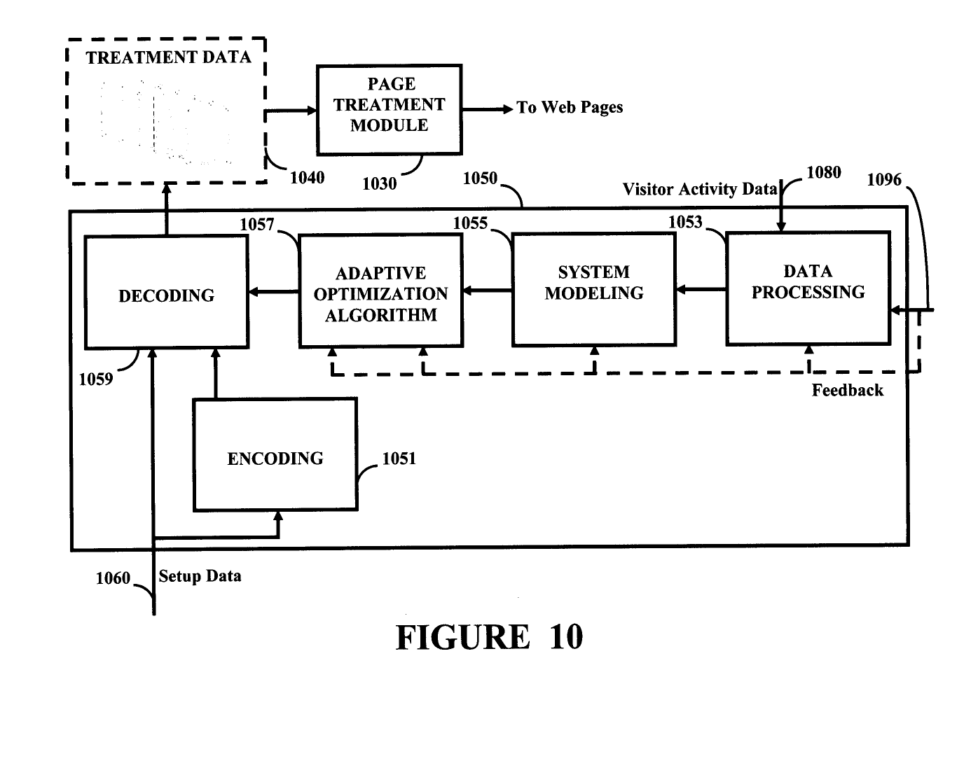

The data flows of the real-time adaptive optimization controllers such as the ones numbered 850, 854 and 858 with respect to FIG. 8, and the ones numbered 950 and 954 with respect to FIG. 9 will now be described. The optimization controller 1050 in FIG. 10 is a non-integrated one, such as the ones in FIG. 8. The real-time adaptive optimization controller 1050 (similar to the ones 650 or 750 in FIGS. 6 and 7, respectively) is not a standard or commonly used feedback control module utilized in industrial optimal control applications. This is because, as described in the Background section of this letters patent, a causal model of the website content, style, or functional changes does not exist, and as result the optimization campaign input values, such as button image, page layout change, addition of a new hyperlink on the web page do not have ordered values associated with their impact to the performance of the website. Additionally, it is the inherit nature of online business that website visitor reaction to the optimization campaign input values changes over time, which implies that traditional statistical approaches for measuring the impact of the input value are ineffective. Finally, the optimization campaign input values interact with each other, making the overall problem of finding an optimal solution even more convoluted and complex. To respond to these conditions, the real-time adaptive optimization controllers of the present invention have the attributes further described below.

The real-time adaptive optimization controller 1050 receives data from multiple sources, including visitor activity data 1080, optimization feedback 1096, and optimization campaign setup data 1060. An encoding module 1051 receives the optimization campaign setup data 1060 and maps that information into set of variable values as required by the specific adaptive optimization algorithm 1057 used by the controller. A multivariate optimization campaign could have two variable elements, such as an “Add to Cart Button” or a trust badge, for example. For each of the above-mentioned elements there are two graphical alternatives. The encoding mechanism 1051 might forward this information to the algorithm 1057 as two variables having two alternate values for each represented by a pointer to the memory location where images are stored.

A data processing module 1053 receives both visitor activity data 1080 and feedback 1096, and then calculates new sets of values as required by a system modeling module 1055. For example, the data processing function may acquire revenue per visitor values for multiple versions of web pages (multiple web page treatments) and calculate correlation values between the variable elements that have been included in the web page versions.

The system modeling module 1055 receives the output from the data processing module 1053 as well as optional feedback, and uses that data to model website behavior in accordance with the requirements of a specific adaptive optimization algorithm 1057, which algorithm determines the subsequent treatment of web pages. A decoding module 1059 uses the output of the adaptive optimization algorithm 1057 and campaign setup data 1060 to generate web page treatment data 1040. The treatment data contains web content, style, or functional change data. A page treatment module 1030 contains instructions on how to apply the treatment data to the web pages.

Although the data flow in FIG. 10 is represented as continuous, the controller 1050 actually operates at discrete data points when visitor activity data becomes available or meaningful, depending on design choice. For example, if a website has very low visitor traffic then the controller steps might be performed every few hours. Likewise, if a website has high visitor traffic, the controller steps might be performed every few minutes. This discrete nature of the data flow calculations creates a need for algorithm state management where intermediate results are stored in the database for processing in the next algorithm step.

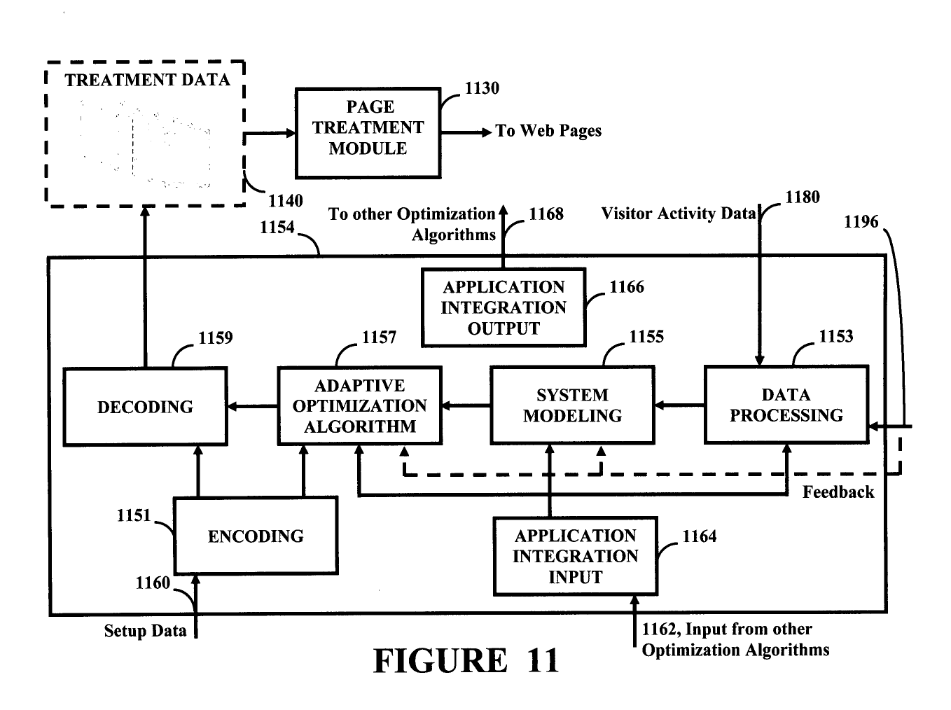

The real-time adaptive optimization controller 1154 in FIG. 11 is designed for integrated real-time adaptive optimization algorithms in a multi-loop environment with referent performance and feedback, and the data flow reflects necessary changes from the data flow in FIG. 10.

The optimization controller 1154 receives input from other operating optimization application(s) via input 1162, which is supplied to an application integration input 1164. The application integration input transforms the data received from other optimization applications into a format that can be used by a data processing module 1153, a system modeling module 1155, as well as the adaptive optimization algorithm 1157. By receiving data about the activities and performance of other optimization algorithms, including embedded optimization applications, the adaptive optimization algorithm 1157 further enhances the multi-loop optimization process.

The encoding and decoding modules 1151 and 1159, as well as the treatment data 1140 and page treatment module 1130 function in the same manner as their counterparts of FIG. 10 (components 1051, 1059, 1040 and 1030, respectively).

One or more application integration outputs 1166 serve to export results from the optimization controller 1154 to other functioning optimization applications.

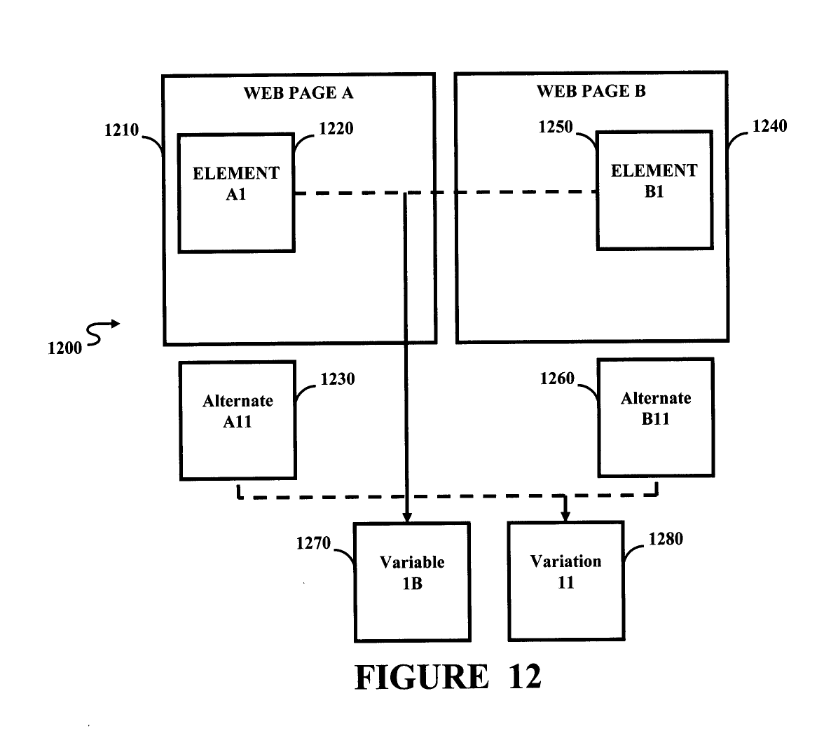

FIG. 12 provides an example of a multi-element encoding schema 1200 to further illustrate the process of data encoding (per modules 1051 of FIGS. 10 and 1151 of FIG. 11). The decoding process (per modules 1059 of FIGS. 10 and 1159 of FIG. 11) is essentially the reverse of the encoding process. In the example of FIG. 12 a client desires to conduct an optimization campaign that will treat two web pages, Web Page A 1210 and Web Page B 1240 at the same. The client also desires to have to web page elements on the corresponding web pages, Element A1 (1220) and Element B1 (1250), treated as a single logical Variable 1B (1270). That single logical variable will have a single Variation 11 (1280) which represents two physical changes on two different web pages at the same time.

The encoding modules 1051 or 1151 (FIGS. 10 and 11) receive information about multiple web pages, multiple web page elements, and multiple alternative values for each of the elements, and then provide to the real-time adaptive optimization controller, only information about the single logical Variable 1B (1270) and one logical alternative value Variation 11 (1280).

If the optimization algorithm decides to present Variation 11, then the decoder 1059 or 1159 will use the setup information to create treatment data 1040 or 1140 that contains the physical values for the Alternate A11 (1230) and Alternate B11 (1260) or 1140 together with page treatment 1030 or 1130 that contains instructions for implementing the treatment data.

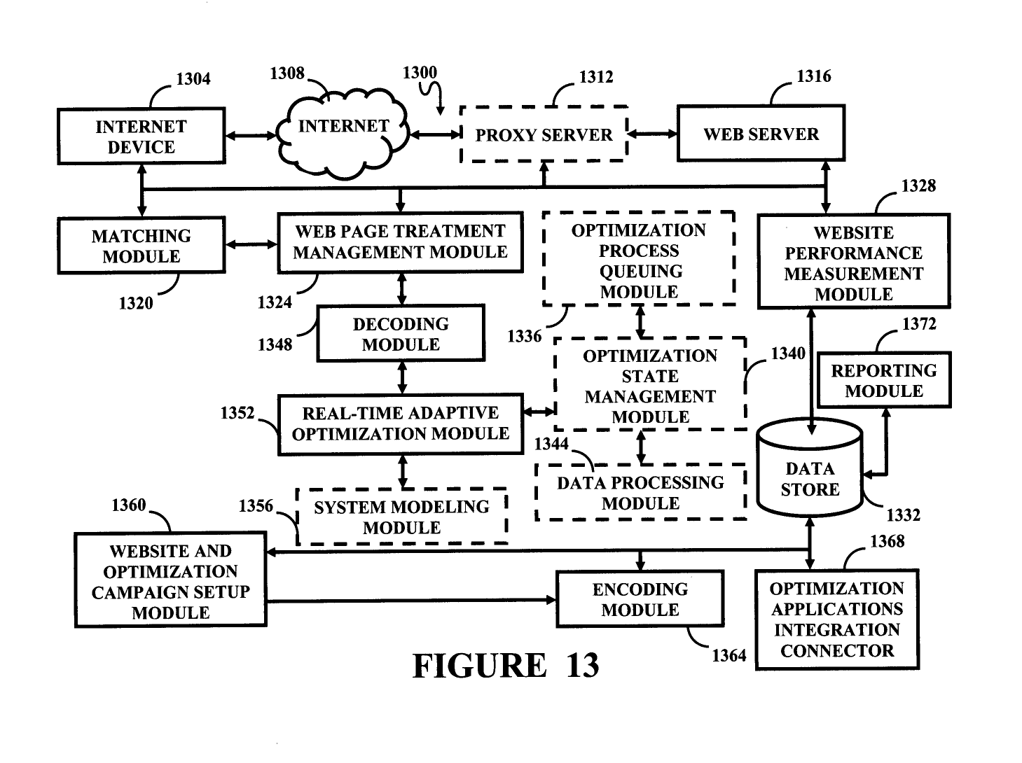

FIG. 13 is a schematic diagram of a system 1300 capable of multi-loop real-time adaptive optimization according to the present invention. In the system 1300, Internet devices 1304 use appropriate application software to access (via the Internet 1308) a website which is hosted by a web server 1316. The Internet devices may be of a number of different types, including PC computers, smart phones, tablet computers, etc. In an alternate embodiment, the functionality of the web server 1316 can be supplemented by a proxy server 1312 as will be familiar to those skilled in the art to which the present invention pertains. Such proxy servers are used for a variety of purposes, including the acceleration of web content delivery, multi-language enablement, protection against denial of service attacks, and many others.

The optimization system 1300 can be integrated with the web delivery system in variety of ways, including directly through Internet devices, via the web server, or the proxy server. The most common integration approach is to use tagging software, which is a segment of computer programming code placed into a web page to be executed by the Internet device while the web page is being loaded in the Internet device. Optimization system integration enables website visitor detection, manipulation of web pages, visitor activity tracking, and other actions as required by the system.

A matching module 1320 matches a website visitor with one or more of the website optimization applications that are utilized as part of a current optimization campaign. The matching process, which is triggered when a website visitor is detected, is carried out in accordance with the information provided by a website and optimization campaign setup module 1360. Once the matching module 1320 determines the optimization application(s) that are associated with the visitor session, a web page treatment management module 1324 fetches the output of a real-time adaptive optimization module 1352 via a decoding module 1348, and treats the web page(s) accordingly. For example, the matching module 1320 might determine that for a website visitor visiting a home page of the website, the home page is assigned to be optimized by a particular optimization application. Matching information is then used to deliver related information of the particular optimization application to the web page treatment management module 1324, which enables web page changes in accordance with the optimization algorithm output.

The type of the integration (see the discussion regarding FIGS. 9 and 11, supra.) between the website and the optimization system web page treatment management module helps determine the web page treatment on the web visitor Internet device, proxy server, or the web server. In the preferred embodiment of the present invention the web page treatment is performed during the page rendering on the website visitor Internet device. Internet devices compatible with the system 1300 typically use web browsing software to download web page code and content from the web server and the web page treatment code and content from the optimization system. The treatment code performs all web page changes in the browser before the page is rendered on the screen of the device and then presents the new version of the web page to the visitor.

The web page treatment management module 1324 also adds visitor tracking in accordance with the optimization configuration setup information received from the website and optimization campaign setup module 1360. A website performance measurement module 1328 collects and processes the visitor tracking data. The primary function of the website performance measurement module 1328 is determining the actual website performance for each of the web page treatments, and to calculate the feedback value as a difference between referent website performance and the actual website performance. The real-time, adaptive optimization module 1352 uses the feedback value to determine how web pages will be treated by the web page treatment management module 1324 when the next visitor or group of visitors is detected.

The functionality of the real-time adaptive optimization module 1324 can be further enhanced through the use of optional, specialized computing modules. A system modeling module 1356 performs complex statistical analysis and data estimation aimed at filtering noisy measurement data or making predictions about the future performance of different web page treatments. An optimization processing queuing module 1336 manages computing resources by queuing or scheduling data processing for one or more optimization application processes at the same time. A data processing module 1344 performs simultaneous mass data processing on one or more servers which enables the large-scale data processing needed for the websites that have millions of visitors per day. And, an optimization state management module 1340 performs discrete optimization steps where the optimization data is collected at all time and periodically processed at discrete time intervals to make the optimization decisions.

The website and optimization campaign setup module 1360 enables the necessary optimization process configuration capabilities using a visual point-and-click interface to enable visual, non-technical selection of web page elements that will be included in the optimization process. The module 1360 also defines which visitor activity data will be collected during the optimization process to define reference performance, the optimization algorithms' optimization criteria, and many other aspects of the optimization process.

An optimization applications integration connector 1368 enables data import and export between optimization applications (i.e., “cross optimization”). A reporting module 1372 presents the optimization data in a format that enables a better understanding of overall results or attributes of the results to different actions or applications. The multi-loop, real-time adaptive optimization system 1300 also nominally includes a data store 1332 for many of the massive data storage functions, and an encoding module 1364 which functions similar to the encoding modules 1051 and 1151 described with reference to FIGS. 10 and 11.

Variations and modifications of the present invention are possible, given the above description. However, all variations and modifications which are obvious to those skilled in the art to which the present invention pertains are considered to be within the scope of the protection granted by this Letters Patent.

What is claimed is:

1. A method of automated, real-time website optimization comprising:
a) receiving web page matching data comprising information about one or more web pages that will be included in a website optimization campaign for optimizing a website;
b) receiving optimization configuration data for one or more website optimization applications;
c) receiving optimization criteria for said one or more website optimization applications;
d) receiving definitions of a referent performance value;
e) receiving instructions for capturing website visitor activity data for said one or more website optimization applications;
f) initializing a real-time, adaptive website optimization algorithm adapted to optimize the overall performance of the website;
g) establishing web page treatment options in accordance with the website optimization algorithm's control;
h) detecting that a website visitor has visited said website;
i) matching a website visitor with one or more web pages according to said web page treatment options;
j) treating web pages in real-time in accordance with the website optimization algorithm's control;
k) capturing website visitor activity data;
l) calculating website performance for each of the web page treatments;
m) calculating feedback on the basis of said referent performance and said website performance;
n) providing said feedback as an input to said website optimization algorithm; and
o) via said website optimization algorithm, determining web page treatment to be applied to web pages to be presented to the next website visitor detected.

2. The method of claim 1, further comprising:
receiving website visitor segmentation and segment grouping criteria adapted to match website visitors with appropriate visitor segments; and
initializing a separate virtual optimization loop for each said visitor segment on the basis of said optimization configuration data.

3. The method of claim 2, further comprising:
collecting optimization results for each virtual optimization loop separately and aggregating the optimization results to generate the overall website optimization results for all visitors.

4. The method of claim 2, further comprising:
calculating feedback values for each virtual optimization loop on the basis of corresponding virtual optimization loop performance;
wherein said real-time adaptive website optimization algorithm is adapted to utilize a plurality of feedback values from each virtual multi-loop optimization loop.

5. The method of claim 2, further comprising:
calculating feedback values for each virtual optimization loop on the basis of corresponding virtual optimization loop performance;
wherein said real-time adaptive website optimization algorithm is adapted to utilize a composite of feedback values calculated for each virtual multi-loop optimization loop and overall website performance values.

6. The method of claim 3, further comprising:
calculating feedback values for each virtual optimization loop on the basis of corresponding virtual optimization loop performance;
wherein said real-time adaptive website optimization algorithm is adapted to utilize a plurality of feedback values from each virtual multi-loop optimization loop.

7. The method of claim 3, further comprising:
calculating feedback values for each virtual optimization loop on the basis of corresponding virtual optimization loop performance;
wherein said real-time adaptive website optimization algorithm is adapted to utilize a composite of feedback values calculated for each virtual multi-loop optimization loop and overall website performance values.

8. The method of claim 1, wherein said web page matching data identifies a web page as an individual web page or a web page template that represents a plurality of individual web pages that share the same page layout and style but contain different content.

9. The method of claim 1, wherein said website optimization configuration data comprises information about variables included in the optimization campaign and the alternate values consisting of programming code, web content, style changes, or other software functionality that will be used to treat web pages;

10. The method of claim 1, wherein said web visitor activity data includes broad variety of data types including but not limited to visitor segmentation information, actions taken, time instances when actions were taken, pages visited, monetary values of individual visits, text or other information captured on live web pages during web page visit.

11. The method of claim 1, wherein said optimization criteria comprises conversion rate, revenue per visitor, average order value, time on site, pages visited, content downloads, or number of purchases.

12. The method of claim 1, wherein said referent performance comprises a plurality of reference value types comprising the real-time website baseline performance during the website optimization campaign, historical website performance, and relative performance improvement against the real-time baseline website performance.

13. The method of claim 1, wherein said optimization configuration data for one or more of website optimization applications comprises identifying information about web page components that will be replaced by the variable or identifying information about a web page location where the variable will be inserted into the web page, and wherein said instructions include how to manipulate a web page to deliver each variable in a format that enables page manipulation on different devices, software platforms, and software applications, including but not limited to the PC browser, mobile device browser, proxy server, web servers, e-commerce server and e-commerce content management platform.

14. The method of claim 1, further comprising:
encoding information received via elements a) through e) and mapping the encoded information into a data format adapted to be utilized by said real-time adaptive website optimization algorithm.

15. The method of claim 14, further comprising:
decoding and mapping the output of the optimization algorithm's output into a data format adapted to be utilized for the treatment of web pages.

16. The method of claim 1, further comprising:
processing and statistically analyzing visitor activity and feedback data.

17. The method of claim 1, further comprising:
Performing data modeling in accordance with real-time adaptive website optimization algorithm requirements.

18. The method of claim 1, further comprising:
preserving the real-time adaptive website optimization algorithm's state and data created or used during the execution of discrete optimization steps for one or more website optimization applications.

19. The method of claim 1, wherein said optimization campaign configuration data comprises information about variables that are embedded optimization applications with alternate values defining how to perform changes in content, style, or functionality of the embedded optimization applications.

20. The method of claim 1, further comprising:
receiving data from other website optimization applications in an acceptable format for the real-time adaptive website optimization algorithm, data modeling, or data processing for achieving the overall website optimization results among all applications from which data was received.

21. The method of claim 1, further comprising:
exporting the real-time adaptive website optimization algorithm's data into other website optimization applications in an acceptable format for the other optimization applications.

22. The method of claim 11, further comprising:
defining multiple web page element changes located on one or more web pages as a single optimization variable or a single alternate value of the said variable.

23. The method of claim 1, further comprising:
processing said visitor activity data to produce reports that attribute the contribution of one or more optimization applications to overall website performance on the basis of all web visitors or per visitor segment basis.

24. A system for automated, real-time website optimization comprising:
a) an Internet device adapted to allow website access by an Internet user;
b) a web server adapted to host a website;
c) a web page matching module adapted to detect activity of the Internet device with respect to said website, and adapted to receive web page matching data comprising information about one or more web pages that will be included in a website optimization campaign for optimizing a website;
d) a web page treatment module adapted to receive optimization configuration data for one or more website optimization applications, adapted to receive optimization criteria for said one or more website optimization applications, and adapted to treat web pages in real-time in accordance with instructions received;
e) a website performance measurement module adapted to receive definitions of a referent performance value, and adapted to measure the performance of a treated website with respect to said referent performance value;
f) a visitor activity data module adapted to capture website visitor activity data for said one or more website optimization applications; and
g) a real-time, adaptive website optimization module operatively coupled to said website performance measure module and to said web page treatment module, and adapted to optimize the overall performance of the website via one or more real-time, adaptive optimization algorithms, adapted receive a feedback value, said feedback value being calculated based on a comparison between said referent performance value and the performance of said website, and adapted to, based upon said feedback, instruct said web page treatment module.

25. The optimization system of claim 24, further comprising:
a communication link adapted to enable real-time communication and data exchange between the elements of the system.

26. The optimization system of claim 24, further comprising:
an optimization setup module adapted to enable website optimization setup data entry and preparation.

27. The optimization System of claim 24, further comprising:
an optimization applications integration connector adapted to enable sharing capabilities between different optimization applications;

28. The optimization System of claim 24, further comprising:
a reporting module adapted to provide end user access to optimization data;

29. The optimization system of claim 24, further comprising:
a system modeling module adapted to enhance the real-time adaptive module performance through data noise filtering or data modeling that predicts future performance;
an optimization process queuing module adapted to enable queuing and scheduling of optimization activities for one or more optimization applications;
a data processing module adapted to enable multi server data processing for elastic computing capacity increase; and
an optimization state management module adapted to enable discrete optimization processing for one or more optimization applications.

30. The optimization system of claim 24, further comprising:
a data storage module adapted to store website optimization data.

31. A method for automated, real-time website optimization comprising:
a) receiving website funnel information including identification of potential web pages for participation in an optimization campaign;
b) receiving optimization variables representing aspects of web pages associated with a website targeted for optimization to optimize the targeted website;
c) receiving optimization criteria indicative of website performance;
d) receiving an optimization reference value;
e) contemporaneously operating a first optimization control loop and at least one additional control loop, the first and additional control loops participating in a single website optimization campaign, each control loop separately executing an optimization algorithm;
f) selecting and delivering to website visitors participating in an optimization campaign, web pages in accordance with optimization algorithms;
g) collecting website visitor activity data;
h) in response to the visitor activity data and the website criteria, generating an optimization result;
i) comparing the optimization result with the reference value and generating a difference between the two;
j) in response to the difference in (i) and additional collected website visitor activity data, generating feedback indicia, and supplying the feedback indicia to an input of at least one of the control loops; and
k) in response to said feedback, performing at least an additional control loop optimization algorithm iteration to converge to an optimized web page state.

32. The method of claim 31, wherein the optimization result is supplied to an input of each optimization control loop.

33. The method of claim 31, wherein at least one of the additional control loops receives at an input, output information from said first control loop.
